(19) United States
(12) Patent Application Publication
(10) Pub. No.: US 2006/0085811 A1
(43) Pub. Date: Apr. 20, 2006

(54) Disk cartridge

(76) Inventors: Tomio Yamamoto, Kobe-shi (JP); Akira Kurozuka, Fujlidera-shi (JP); Takatoshi Yukimasa, Ibaraki-shi (JP)

Correspondence Address: RATNERPRESTIA, P.O. BOX 980, VALLEY FORGE, PA, 19482, US

(21) Appl. No.: 10/530,311

(22) PCT Filed: Oct. 1, 2003
(86) PCT No.: PCT/JP03/12622

§ 371 Date: Dec. 6, 2005

(30) Foreign Application Priority Data
Oct. 4, 2002 (JP) 2002-292167
Jan. 10, 2003 (JP) 2003-004468

(51) Int. Cl. G11B 23/03

(52) U.S. Cl. 720/740

(57) ABSTRACT

The disc cartridge according to the present invention comprise: a cartridge body including a disc housing section for housing a disc so as to be rotatable, which is provided with an opening for exposing a part of the disc; a shutter member which is movable to open or close the opening; a shutter driving spring for applying a force to the shutter member not to open the opening in a closing state in which the shutter member closes the opening; and a locking portion for locking the shutter member.

### TECHNICAL FIELD

The present invention relates to a disc cartridge, more specifically, a disc cartridge for housing a disc, i.e., an information recording medium for recording information, into a cartridge body.

### BACKGROUND ART

A disc such as a magnetic disc or an optical disc is known as an information recording medium for recording information.

A disc is also used as an audio disc or a video disc. Further, a disc is also used as an information recording medium of a data storage apparatus of a computer.

For driving such a disc, e.g., an optical disc, an optical disc apparatus is widely used as a disc drive apparatus.

As the recording density of a disc increases, there has been more demand for an optical disc apparatus having a larger capacity and a smaller size. Not only audiovisual (AV) equipment, but also personal computers nave been miniaturized and made to be portable. Thus, it is desired to reduce the size and the thickness of an optical disc apparatus.

In general, a disc which can record information is housed into a cartridge body to prevent dust or fingerprints attaching to the disc. Such a disc cartridge for housing a disc into a cartridge body is disclosed in, for example, Japanese Patent Nos. 3030894 and 3178047.

A disc cartridge described in Japanese Patent No. 3030894 (particularly, in paragraphs 0020 to 0024 and 0034, and FIGS. 1 and 5) and Japanese Patent No. 3178047 (particularly, in paragraphs 0030 to 0034, and FIGS. 1, 2 and 4) is used for an MD (minidisk).

In such a disc cartridge, a disc is housed in a cartridge body. In the cartridge body, an opening for exposing a part of the disc in provided.

A disc cartridge has a movable shutter for opening or closing the opening. The shutter moves (specifically, slides) in the same direction as a direction of inserting a disc cartridge into a disc driving apparatus to open or close the opening.

The shutter has a substantially squared C-shaped cross section. Detachment prevention projections are provided on a bottom surface of the shutter. The shutter pinches the cartridge body with the detachment prevention projections engaged with a guide groove formed on a bottom surface of the cartridge body. Thus, the shutter slides in the direction of inserting the disc cartridge into the disc drive apparatus. In the cartridge body, such a guide groove is provided in a portion closer to an outer periphery than the opening.

The disc cartridge also comprises a locking member for locking the shutter with the shutter closing the opening. The locking member is provided in a portion closer to the tip in a direction of inserting the disc cartridge to the disc drive apparatus than the opening.

In the disc drive apparatus, a cartridge holder, to which the disc cartridge is mounted, is provided. On an inner surface of the cartridge holder, a fixed opener pawl is provided.

When the disc cartridge is inserted into the disc drive apparatus, the opener pawl passes through a groove provided on a side surface of the disc cartridge, presses the locking member to release the lock of the shutter. Then, the shutter in moved in a rear direction and the opening is opened.

With the opening being opened, a recording/reproduction head of the disc drive apparatus is inserted into the opening. Thus, it in possible to record information on the disc housed in the cartridge body or reproduce information recorded on the disc.

The opener pawl in not able to close the shutter when the disc cartridge is removed from the disc drive apparatus. Thus, it is required to provide a leaf spring in the disc drive apparatus for closing the shutter when the disc cartridge is removed from the disc drive apparatus. The leaf spring slides the shutter by engaging to a hole provided on the side surface of the shutter and holding the shutter. Thus, the opening is closed.

Usually, portions around the four corners of the bottom surface of the cartridge body serve as reference planes. When the disc cartridge is mounted to the disc drive apparatus, a mechanical chassis is provided in a position corresponding to reference planes of the cartridge body. Installation surfaces are provided on the mechanical chassis. For mounting the disc cartridge to the disc drive apparatus, the disc cartridge in pressed from above to position the disc cartridge with respect to the disc drive apparatus.

However, the disc cartridge disclosed in Japanese Patent Nos. 3030894 and 3178047 has the following problems.

When the disc cartridge is removed from the disc drive apparatus, the resistance of the leaf spring which serves to have the shutter closes the opening is felt and thus the feeling of operation is not good. If the force of the leaf spring to hold the shutter is weakened to reduce the resistance, there the shutter may not be closed with certainty.

If the disc cartridge is removed from the disc drive apparatus without the shutter closing the opening, foreign matter such as dust enter trough the opening and attach to the disc. This may hinder recording and reproduction of the disc.

Further, it is required to provide a dedicated locking mechanism for locking the shutter with the shutter closing the opening. Thus, the degree of freedom in design, such as, to provide large curvature in a corner of a square-shape cartridge body, is largely spoiled. For providing a disc cartridge which corresponds to a disc having a smaller size, the available area for the locking mechanism is relatively decreased. Thus, the space for the looking mechanism itself cannot be secured.

In order to prevent the shutter being left open, an embodiment in which a force is applied by a spring in a direction to close the shutter can be also considered. However, when a disc cartridge without the locking mechanism is carried, a position of the shutter can be readily shifted by an external force and dust and foreign matter enters more easily. Furthermore, if both the spring and the locking mechanism are provided, the number of parts increases, thereby increasing the cost for the disc cartridge.

The guide groove for guiding a direction of movement of the shutter is provided on the bottom surface of the cartridge body. At least one of the detachment prevention projections provided in the shutter is engaged with the guide groove. On the bottom surface of the cartridge, not only the guide portion but also the opening is provided. Thus, the shutter moves around the opening. As a result, the portions around the opening are required to have plane surfaces. An outer periphery portion or the opening is required to have a sufficient space to avoid interference with a lens actuator of the recording/reproduction head to be inserted into the opening. Since the guide groove is formed in a portion outside the opening, the width of the cartridge body becomes large.

If the guide groove is located in an inner portion, the guide groove may communicate with the opening. In this case, even when the shutter closes the opening, a path for dust to enter through the guide groove may be formed.

As the size of the disc decreases, the relative size of the recording/reproduction head of the disc drive apparatus increases. Thus, the installation surface of the mechanical chassis which faces the reference planes in the vicinity of the opening interferes with the recording/reproduction head. In order to avoid this, it is required to locate the recording/reproduction head in a lower position, apart from the cartridge body. Thus, the thickness of the disc drive apparatus becomes large.

The objective of the present invention in to solve the above-described problems by providing a disc cartridge which has a simple structure to reduce cost, has an enhanced dust-proofing ability, and which can be miniaturized.

### DISCLOSURE OF THE INVENTION

A disc cartridge according to the present invention comprises: a cartridge body including a disc housing section for housing a disc so as to be rotatable, which is provided with an opening for exposing a part of the disc; a shutter member which is movable to open or close the opening; a shutter driving spring for applying a force to the shutter member not to open the opening; and a locking portion for locking the shutter member.

The locking portion may be locked using the shutter driving spring.

The cartridge body may include a first case and a second case; and the first case ad the second case may be integrally combined to form a disc housing section.

The cartridge body may be provided with positioning holes for defining the position of the disc cartridge with respect to a disc drive apparatus for driving the disc when the disc cartridge is mounted to the disc driving apparatus.

The cartridge body may include a first case and a second case; the first case and the second case may be integrally combined to form a disc housing section; and the positioning holes may be provided so as not to penetrate the first case and the second case.

The shutter member may include a spring engagement portion to be engaged with the shutter driving spring; and the shutter member and the shutter driving spring may slide in the spring engagement portion at a substantially right angle with respect to a direction of a movement of the shutter member in a closing state in which the shutter member closes the opening.

The cartridge body may be provided with a lock recessed portion to which the shutter driving spring is engaged at a substantially right angle with respect to a direction of the movement of the shutter member in a closing state in which the shutter member closes the opening.

A recessed-shape guide groove portion which is opened to the outside of the cartridge body may be provided on a side surface of the cartridge body to be engaged with the shutter member; and one end of the shutter arriving spring may move along the guide groove portion.

An inclined surface for movement of the one end of the shutter driving spring to the lock recessed portion may be provided on a surface of the spring engagement section to abut the one end of the shutter driving spring.

The first case may be provided with an upper engagement groove for guiding the movement of the shutter member and holding the shutter member: and the second case may be provided with a lower engagement groove for guiding the movement of the shutter member and holding the shutter member.

The shutter member may be provided with an upper engagement protruded portion to be engaged with the upper engagement groove, and a lower engagement protruded portion to be engaged with the lower engagement groove.

The lower engagement groove may be provided so as to be spaced apart from the opening by a predetermined distance.

A bridging portion for bridging an outer periphery portion of the opening may be provided in the second case; the bridging portion may have a lower surface substantially coplanar to a surface of the disc when a disc drive apparatus for driving the disc drives the disc and an upper surface which is a surface coplanar to a surface of the opening close to an edge of the cartridge body and is extended in a direction of closing the shutter member; a side surface of the first case may be provided with a notch; and the notch of the first case and the upper surface of the bridging portion may form a groove.

The second case may be provided with an opening range restriction portion for restricting an opening area of the shutter member; a major surface of the second case to be mounted on a disc drive apparatus for driving the disc may be provided with planar holding portions recessed from the major surface in the vicinity of corners to which the shutter member is engaged which opposes the open area restriction portion via the opening.

The disc cartridge may further comprise a lock release portion for releasing the look of the locking member.

The look release portion may be in contact with the shutter driving spring.

The lock release portion may comprise a pressed portion to be pressed by a disc drive apparatus for driving the disc, and the lock release portion may be provided so as to be movable in a direction that the shutter member opens or closes the opening.

The lock release portion may enter a lock released state by pressing the pressed portion with the shutter member closed and looked, and then move with the shutter member to the opening position integrally with the shutter member.

### BRIEF DESCRIPTION OF THE DRAWINGS

FIG. 1 in an exploded perspective view showing a disc cartridge according to Embodiment 1 of the present invention;

FIG. 2 is a perspective view mainly showing the inner surface of an upper half in Embodiment 1;

FIG. 3 is a perspective view mainly showing the outer surface of a lower half in Embodiment 1;

FIG. 4 is a perspective view of a shutter in Embodiment 1;

FIG. 5 is a plan view of an important part showing the inner surface of the lower half in Embodiment 1;

FIG. 6 is a plan view showing the inner surface of the lower half in Embodiment 1;

FIG. 7 is a cross-sectional view of an important part of the disc cartridge in Embodiment 1;

FIG. 8 is a cross-sectional view of another important part of the disc cartridge in Embodiment 1;

FIG. 9 to a perspective view mainly showing the outer surface of the upper halt of the disc cartridge with the shutter closing the opening in Embodiment 1;

FIG. 10 in a perspective view mainly showing the outer surface or the lower half of the disc cartridge with the shutter closing the opening in Embodiment 1;

FIG. 11 is a perspective view mainly showing the outer surface of the upper half of the disc cartridge with the shutter opening the opening in Embodiment 1;

FIG. 12 is a perspective view mainly showing the outer surface of the lower half of the disc cartridge with the shutter opening the opening in Embodiment 1;

FIG. 13 is a perspective view of an important part of a holder on which the disc cartridge according to Embodiment 1 is mounted;

FIG. 14 is a plan view or an important part illustrating the lock release operation in Embodiment 1;

FIG. 15 is a plan view of an important part illustrating the lock release operation in Embodiment 1;

FIG. 16 is a plan view of an important part illustrating the lock release operation in Embodiment 1;

FIG. 17 is a plan view of an important part illustrating the lock release operation in Embodiment 1;

FIG. 18 is a plan view of an important part illustrating the lock release operation in embodiment 1;

FIG. 19 is a cross-sectional view of an important part showing the disc cartridge when it is mounted in Embodiment 1;

FIG. 20 is an exploded perspective view showing a disc cartridge according to Embodiment 2 of the present invention;

FIG. 21 is a perspective view mainly showing an outer surface of an upper half of the disc cartridge with a shutter closing an opening in Embodiment 2;

FIG. 22 is a perspective view mainly showing an outer surface of a lower half of the disc cartridge with the shutter closing the opening in Embodiment 2;

FIG. 23 is a perspective of the shutter in Embodiment 2;

FIG. 24 is a perspective view of an important part illustrating a structure around the shutter of Embodiment 2;

FIG. 25 is a perspective view mainly showing inside the lower half in Embodiment 2;

FIG. 26 is a plan view of an important part illustrating an operation of the shutter opening the opening in Embodiment 2;

FIG. 27 is a plan view of an important part illustrating an operation of the shutter opening the opening in Embodiment 2;

FIG. 28 is a plan view of an important part illustrating an operation of the shutter opening the opening in Embodiment 2; and

FIG. 29 is a plan view of an important part illustrating an operation of the shutter opening the opening in Embodiment 2.

### BEST MODE FOR CARRYING OUT THE INVENTION

Hereinafter, embodiments of the present invention are described with reference to the drawings.

### Embodiment 1

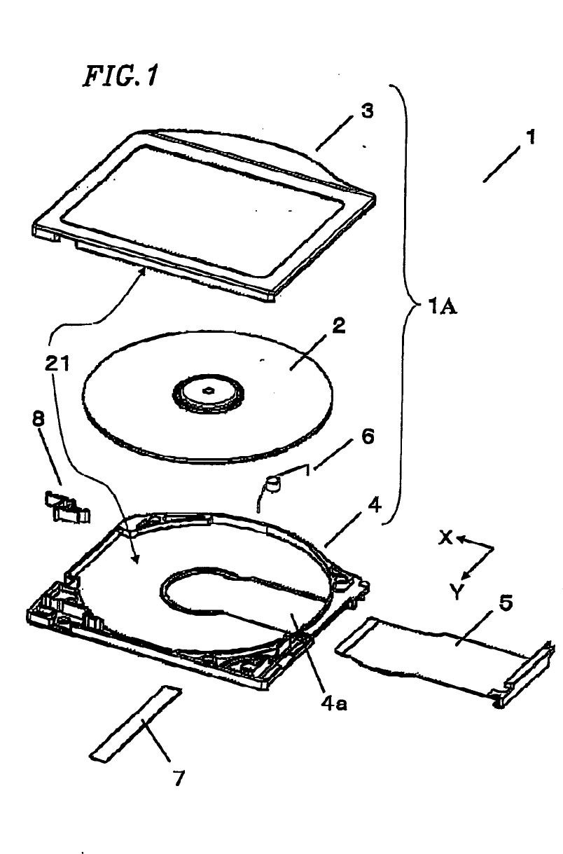

FIG. 1 is an exploded perspective view showing a disc cartridge 1 according to Embodiment 1 of the present invention.

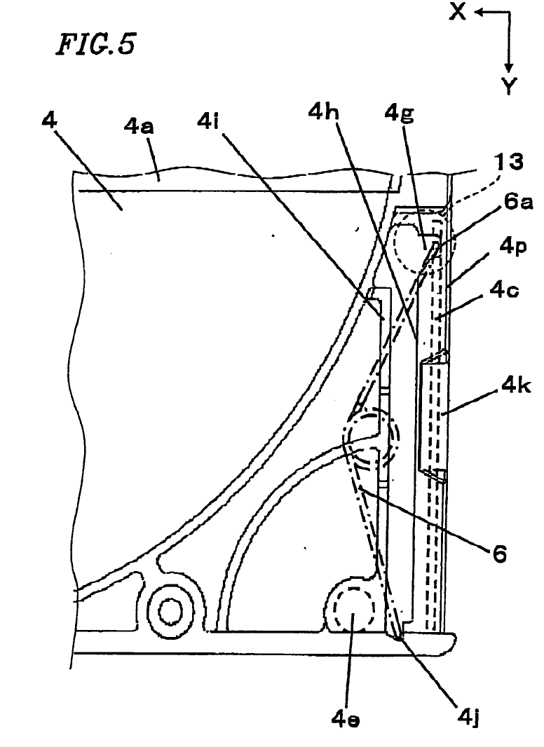

The disc cartridge 1 has a cartridge body 1A including a disc housing section 21 for housing a disc 2 so as to be rotatable and in which an opening 4a for exposing a part of the disc 2 is provided, a shutter 5 which is movable so as to open or close the opening 4a, a shutter driving spring 6 for applying a force to the shutter 5 not to open the opening 4a, and a locking portion 13 (which will be described later with reference to FIG. 5) for locking the shutter 5.

The disc cartridge 1 is inserted into the disc drive apparatus (not shown) in −Y direction shown in FIG. 1. After the disc cartridge 1 is mounted to the disc drive apparatus, the disc drive apparatus drives the disc 2. Specifically, the disc drive apparatus records information on the disc 2 or reproduces the information recorded on the disc 2.

The cartridge body 1A includes an upper half 3 which serves as an upper case and a lower half 4 which serves as a lower case. The upper half 3 and the lower half 4 are integrally combined to form the disc housing section 21.

In FIG. 1, an outer surface of the upper half 3 and an inner surface of the lower half 4 are illustrated.

To the lower half 4, the shutter 6 is attached. The shutter 5 moves (more specifically, slides) in Y direction and the −Y direction which are parallel to the direction of inserting the disc cartridge 1 into the disc drive apparatus (not shown) to open or close the opening 4a. In the descriptions below, a position where the shutter 5 opens the opening 4a is referred to as an opening position of the shutter 5, or, simply, an opening position. A position where the shutter 5 closes the opening 4a is referred to as a closing position of the shutter 5, or simply, a closing position.

Either the upper half 3 or the lower half 4 has a curved shape of a large curvature (R) at a tip to be inserted into the disc drive apparatus (not shown).

The shutter driving spring 6 is a helical torsion spring having both ends bent in a direction parallel to a thickness direction of the disc 2 and in the same direction to each other. The shutter driving spring 6 in provided in the vicinity of the position where the shutter 5 opens the opening 4a. The shutter driving spring 6 applies a force to the shutter 5 such that the shutter 5 moves in a direction to close the opening 4a (i.e., −Y direction).

The tip of the shutter 5 is suppressed by a shutter retainer 7 not to rise up.

On the lower half 4, a switch 8 is provided. By switching the switch 8, it is possible to select whether the disc 2 is in a recordable state or not.

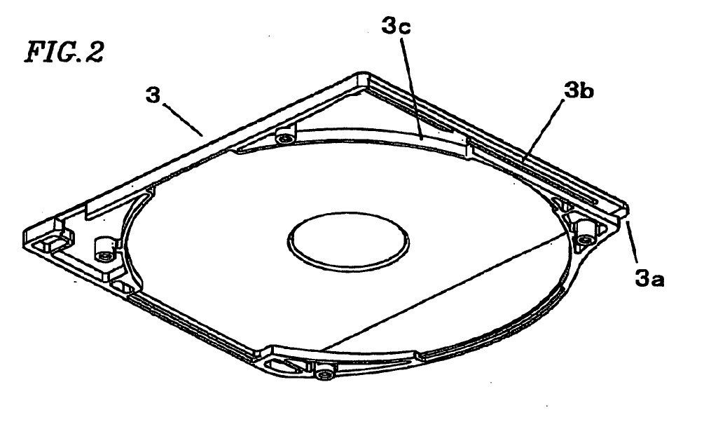

FIG. 2 is a perspective view mainly showing the inner surface of the upper half 3.

On one side of the upper half 3 which opposes one side of the inner surface of the lower half 4 to which the shutter 5 is attached, an eaves portion which extends outward from a disc housing section boundary wall 3c of the upper half 3 provided. In the eaves portion, a side notch 3a is provided at a corner in the vicinity of the closing portion of the shutter 5 in a form with a part of a surface opposing the lower half 4 out therefrom. With such a structure, the side notch 3a and a protrusion of the lower half 4 form a side surface groove on a side surface of the disc cartridge 1. In the eaves portion, an upper engagement groove portion 3b is provided along one side of the upper half 3, which opposes one side of an inner surface of the lower half 4 to which the shutter 5 is attached.

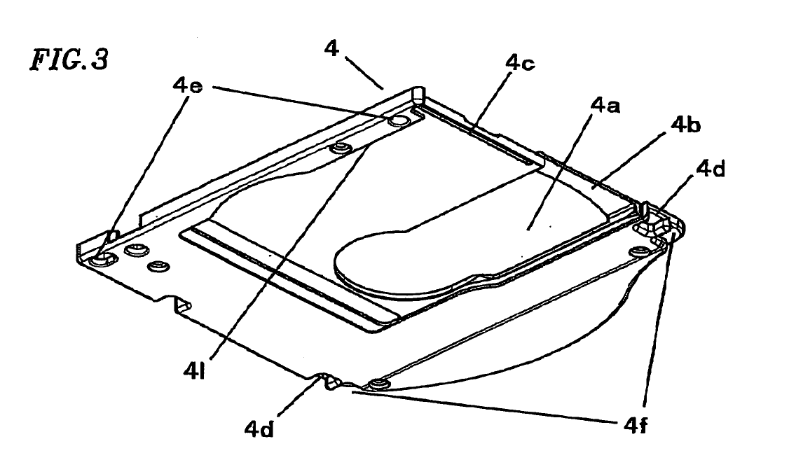

FIG. 3 is a perspective view mainly showing the outer surface of the lower half 4.

When the disc cartridge 1 is mounted to the disc drive apparatus (not shown), the recording/reproduction head and a spindle of the disc drive apparatus are inserted into the opening 4a for recording information on the disc 2 reproducing information on the disc 2. A bridging portion 4b for bridging the outermost periphery of the opening 4a has a width substantially the same as that of the opening 4a and has a thickness smaller than that of the thickset part of the lower half 4, with a part of an external surface of the lower half 4 cut therefrom.

On an edge of the outer surface of the lower has 4 close to a side surface on which the shutter 5 moves, a lower engagement groove portion 4c is provided. The lower management groove portion 4c is spaced apart from the opening 4a by a predetermined distance so as not to communicate with the opening 4a.

In the lower half 4, an opening range restriction portion 41 for restricting an opening area of the shutter 5 when the opening 4a is opened is provided. In the vicinity of both edge sides of the lower half 4 which oppose the opening range restriction portion 41, holding portions 4d for the disc drive apparatus to hold the cartridge 1 are provided.

In the vicinity of the terminal end in a direction of inserting the disc cartridge 1 into the disc drive apparatus (not shown) (i.e., in the vicinity of the opening range restriction portion 41), positioning holes 43 are provided. The positioning holes 4e are used for defining the position of the disc cartridge 1 with respect to the disc drive apparatus when the disc cartridge 1 is mounted to the disc drive apparatus.

In corners of the tip portion in the direction of inserting the disc cartridge 1 into the disc drive apparatus (not shown), corner recessed portions 4f out in a front edge and on a side surface are provided. The corner recessed portions 4f are provided in corners of the lower half 4 in portions closer to the outer periphery than the holding portions 4d in the lower half 4. The corner recessed portions 4f are used as reference planes with respect to a height direction when the cartridge 1 is mounted to the disc drive apparatus. The holding portions 4d have planes recessed from the major surface of the lower half 4 of the disc cartridge 1.

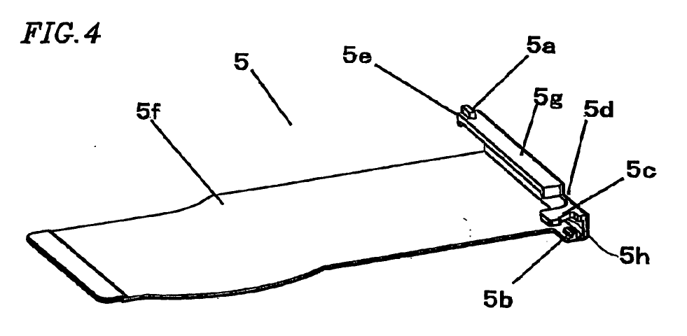

FIG. 4 is a perspective view showing a structure of the shutter 5.

The shutter 5 includes a plate portion 5f for closing the opening 4a at the closing position of the shutter 5 and a squared C-shaped portion 5g bent into a substantially squared C-shape from one end of the plate portion 5f. The shutter 5 is assembled so as to pinch the lower half 4 (the details will be described later).

On one end of an upper surface of the squared C-shaped portion 5g, an upper engagement protrusion 5a is provided. On the upper surface of the plate portion 5f, a lower engagement protrusion 5b is provided. The upper engagement protrusion 5a is provided so as to have a diagonal relationship with the lower engagement protrusion 5b.

A spring engagement portion 5c is formed above the lower engagement protrusion 5b at a position lower than an upper side surface of the squared C-shaped portion 5g. The upper side surface of the squared C-shaped portion 5g and the upper portion of the spring engagement portion 5c form a notch 5d. The shutter driving spring 6 abuts a spring abutment surface 5h of the spring engagement portion 5c.

An end surface of the upper engagement protrusion 5a of the squared C-shaped portion 5g is an opener abutment surface 5e. A shutter opener of the disc drive apparatus (not shown) abuts the opener abutment surface 5e, and thus, the shutter 5 moves to open the opening 4a.

FIG. 5 is a plan view of an important part showing the inner surface of the lower half 4.

Inside the lower half 4, as shown in FIG. 3, a raised portion 4p with a locking recessed portion 49 and a spring sliding surface 4h is formed so as to locate on the back of the lower engagement groove portion 4c provided on the outer surface of the lower half 4. A spring guide rib 4i is provided in parallel with the spring gliding surface 4h. The shutter 5 is assembled so as to be inserted at a position of an inclined portion 4k with the lower engagement protrusion 5b fit into the lower engagement groove portion 4c.

One end of the shutter driving spring 6 is supported by the spring supporting portion 4j so as to position above the spring guide rib 4i and the other end of the shutter driving spring 6 abuts the spring abutment surface 5h of the spring engagement portion 5c of the shutter 5.

A tip portion 6a within a region of the locking recessed portion 4g and a tip portion 6b which is engaged with the spring supporting portion 4j of the shutter driving spring 6 are vertically bent in the same direction as the thickness direction of the upper half 3 and the lower half 4.

As shown in FIG. 5, the locking portion 13 locks the shutter 5 by the tip portion 6a of the shutter driving spring 6 and the locking recessed portion 4g.

Typically, the positioning hole 4e is located in the vicinity of a corner of a surface of the disc cartridge 1 to be mounted to the disc drive apparatus (i.e. the bottom surface of the surface of the cartridge body 1A) (not shown). The positioning hole 4e is positioned just beside the spring supporting portion 4j. The positioning hole 4e has a depth sufficient for inserting a positioning pin of the disc drive apparatus, but an upper surface of the positioning hole 4e is blocked. The positioning hole 4e is provided on a coplanar surface as the spring guide rib 4i. The spring guide rib 4i and the inner surface of the upper half 3 define a predetermined gap. The shutter driving spring 6 moves between the gap. Herein, the positioning hole 4e is provided so as not to penetrate the upper half 3 and lower half 4. However, the gap may communicate with the positioning hole 4e.

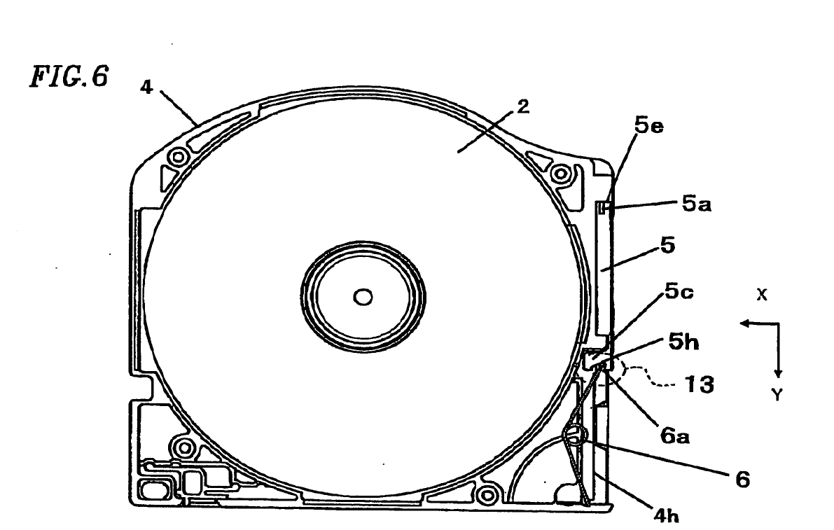

FIG. 6 is a plan view showing the inner surface of the lower half 4.

FIG. 6 shows the lower half 4 with the shutter 5 and the shutter driving spring 6 incorporated therein.

To the shutter 5 is applied a force in the −Y direction by the shutter driving spring 6 and closes the opening 4a. The spring engagement portion 5c is provided so as to have a predetermined width such that the tip portion 6a of the shutter driving spring 6 is slidable in the X axis direction. The spring abutment surface 5h is formed so as to incline toward the outside of the cartridge.

Thus, when the shutter 5 closes the opening 4a, to cause the tip portion 6a of the shutter driving spring 6 abut the spring abutment surface 5h, the shutter driving spring 6 moves itself in −X direction with a repulsive force to expand itself. Since the tip portion 6a enters the locked recessed portion 4g formed in the lower half 4, it is in a position where it cannot move itself in the Y direction. The shutter 5 is locked at a position closing the opening 4a. An described above, the tip portion 6a of the shutter driving spring 6 is engaged with the locked recessed portion 4g to lock the shutter 5.

A length of the tip portion 6a is longer than a thickness of the raised portion 4p. Thus, the tip portion 6a is exposed on a side surface of the cartridge body 1A. When the tip portion 6a is pressed from the side surface to move toward the disc 2 so as to go out of the region of the locking recessed portion 4g, the tip portion 6a becomes movable along a spring sliding surface 4h. As a result, it becomes possible to slide the shutter 5 in an opening direction (Y direction) to open the opening 4a.

With such a structure, according to the present embodiment, it becomes possible to lock the shutter 5 using the shutter driving spring 6 without providing a new shutter locking mechanism. Also, it becomes possible to cut the tip of the disc cartridge on which a new shutter locking mechanism is conventionally provided and form it into a curved shape as in the present embodiment.

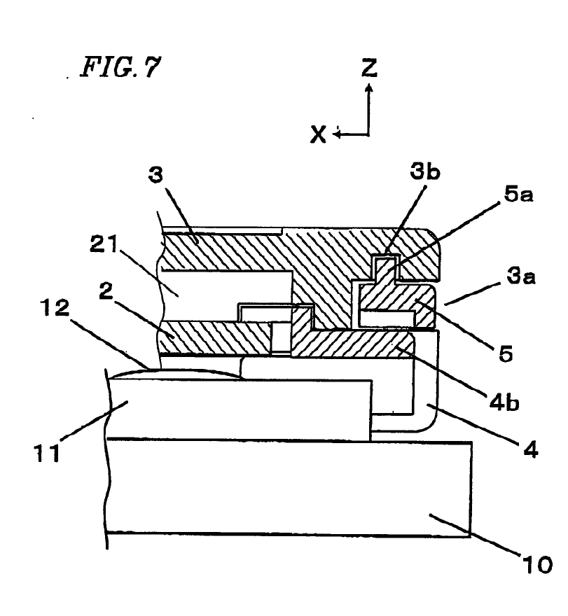

FIG. 7 is a cross-sectional view of an important part of the disc cartridge 1. FIG. 7 shows the disc cartridge 1 with the upper engagement protrusion 5a being guided.

In FIG. 7, the disc 2 housed in the disc housing section 21 is chucked to the spindle of the disc drive apparatus (not shown). The disc 2 housed in the disc housing section 21 is at a position risen to a height of about the middle of the thickness of the disc cartridge 1. The shutter 5 is pinched by the upper half 3 and the bridging portion 4b of the lower half 4 in the side notch 3a of the upper half 3. The upper engagement protrusion 5a is inserted into the upper engagement groove portion 3b. Thus, the shutter 5 is constrained in both the x axis direction and the Z axis direction. The shutter 5 in guided so as to be movable in the Y direction or the −Y direction along the Y axis which is perpendicular to the page.

The upper engagement protrusion 5a passes the position of the opening 4a when the lock of the shutter 5 is released. The upper engagement protrusions 5a is guided within a thickness of the upper half 3. Thus, a lower surface of the bridging portion 4b can be at substantially the same height as a lower surface of the disc 2 and a large space can be provided in the outer periphery portion or the opening 4a without significantly increasing the thickness of the disc cartridge 1.

A lens actuator 11 for actuating a lens 12 of a recording/reproduction head 10 is inserted into the opening 4a. Even when the lens actuator 11 is at the outermost periphery of the disc 2, the lens actuator 11 does not interfere with the disc cartridge 1 and a sufficient space is secured.

The shutter 5 is guided inside the eaves portion extending from side notch 3a in a direction the shutter 5 opens the opening 4a. Thus, the shutter 5 is not exposed on an external surface of the upper half 3. Therefore, the upper engagement protrusion 5a and the upper engagement groove portion 3b can be prevented from being out of engagement. Thereby, a function of the shutter 5 to close the opening 4a is not effected. As a result, damage and contamination such as fingerprints, or dust of the disc 2 housed in the disc cartridge 1 can be prevented. Further, design with respect to the appearance of the disc cartridge 1 is not deteriorated.

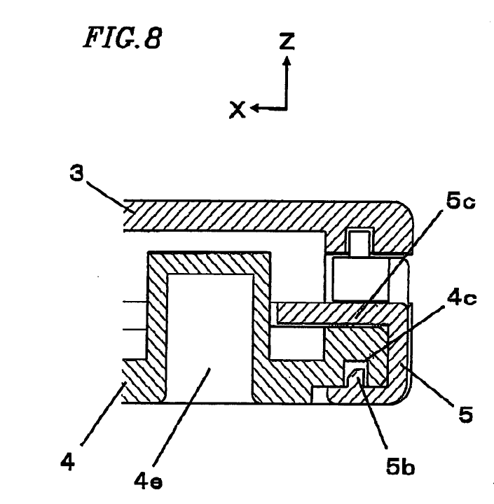

FIG. 8 in a cross-sectional view of another important part of the disc cartridge 1. FIG. 8 shows the disc cartridge 1 with the lower engagement protrusion 5b being guided.

In FIG. 8, the lower engagement protrusion 5b of the shutter 5 is guided to the lower engagement groove portion 4c. The shutter 5 is constrained in the X-axis direction and the Z-axis direction with the under half 4 pinched by the lower engagement protrusion 5b and the spring engagement portion 5c. Since the lower engagement protrusion 5b does not pass the position of the opening 4a, it is possible to be guided in the lower half 4 as shown in the figure.

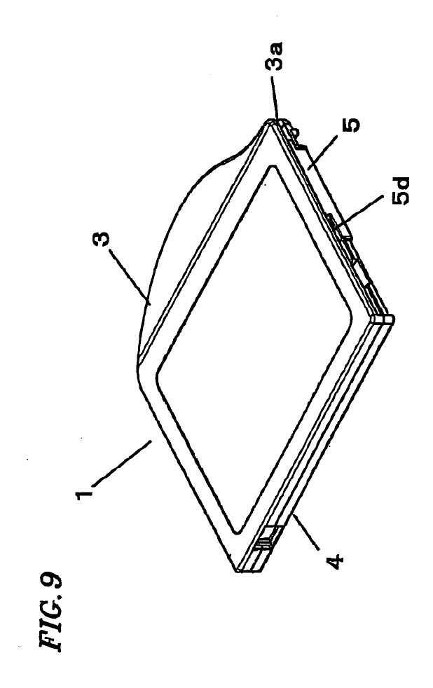

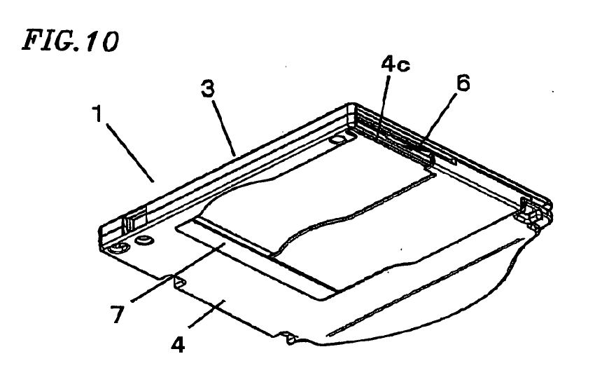

FIG. 9 is a perspective view mainly showing the outer surface of the upper half 3 of the disc cartridge 1 with the shutter 5 closing the opening 4a. FIG. 10 is a perspective view mainly showing the outer surface of the lower half 4 of the disc cartridge 1 with the shutter 5 closing the opening 4a.

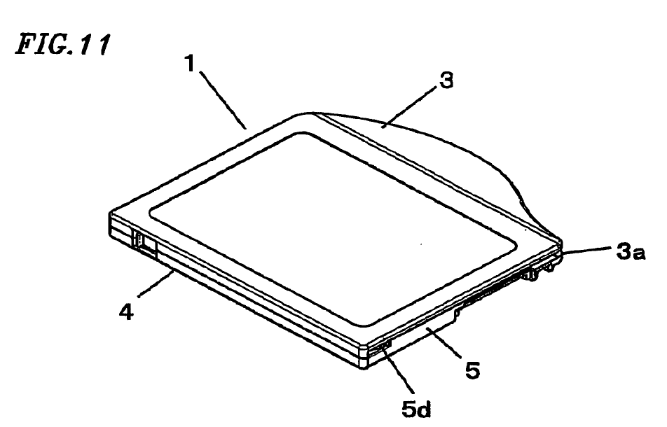

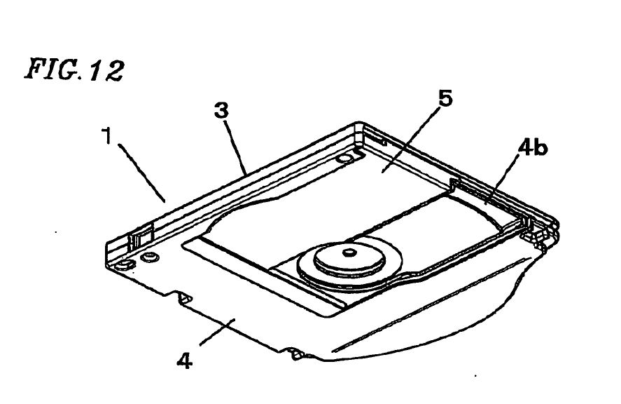

FIG. 11 is a perspective view mainly showing the outer surface of the upper half 3 of the disc cartridge 1 with the shutter 5 opening the opening 4a. FIG. 12 is a perspective view mainly showing the outer surface of the lower half 4 of the disc cartridge 1 with the shutter 5 opening the opening 4a.

As shown in FIGS. 9 through 12, on a side surface of the disc cartridge 1 to which the shutter 5 is engaged, it is possible to touch the tip portion 6a of the shutter driving spring 6 which is exposed from the notch 5b of the shutter 5 without being covered by the raised portion 4p.

When the shutter 5 is at the closing position, the opening 4a is completely covered. The lower engagement groove portion 4c does not communicate with the opening 4a. Thus, there is no path for dust to enter, which enables a highly duct-proof structure.

Next, an operation of the disc cartridge 1 of the present embodiment opening the opening 4a is described.

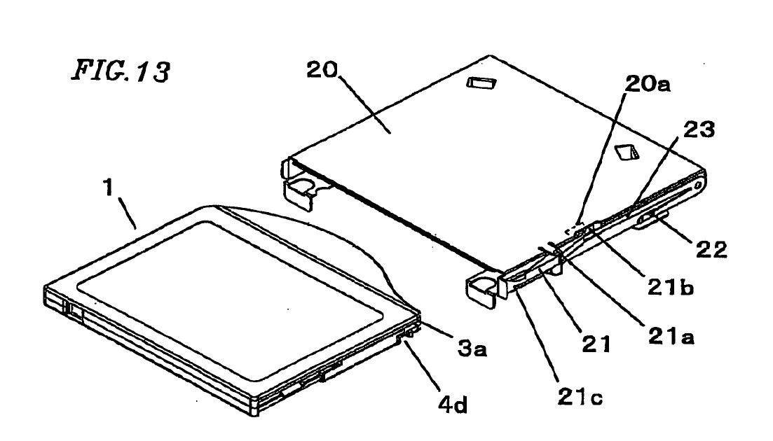

With reference to FIGS. 13 through 16, a structure of a holder 20, on which the disc cartridge 1 according to Embodiment 1 is mounted, is described.

FIG. 13 is a perspective view of an important part of a holder on which the disc cartridge according to Embodiment 1 is mounted.

The disc cartridge 1 is inserted into the holder 20 located on the mechanical chassis (not shown) to which the spindle and the recording/reproduction head are incorporated.

On a side surface of the holder 20 of the side on which the cartridge 1 and the shutter 5 engage, a rotatable axis 21a which rotates a lock release lever 21 by a predetermined angle, a holding spring 22 for holding the disc cartridge 1, and a force-applying spring 23 for applying a small amount of force to the lock release lever 21 so as to rotate outward from the holder 20 are provided. Herein, the force-applying spring 23 is a leaf spring.

The holding spring 22 is located so as to engage with the holding portion 4d of the disc cartridge 1 when the disc cartridge 1 is inserted into the innermost part of the holder 20.

The lock release lever 21 includes a cartridge abutment portion 21b which is located on a front end with respect to direction of inserting the disc cartridge 1 and abuts the side surface of the disc cartridge 1, and a lock release portion 21c which is located on a rear end with respect to the direction of inserting the disc cartridge 1 which presses the shutter driving spring 6.

The lock release lever 21, the cartridge abutment portion 21b and the lock release portion 21c are located such that either the cartridge abutment portion 21b or the lock release portion 21a enter into the holder 20 by rotating the lock release lever 21.

The force-applying spring 23 applies a force to the lock release lever 21 such that the lock release portion 21c retracts to the outside of the holder 20. In the inner side surface of the holder 20, an opener pawl 20a in provided at a height of the side surface notch 3a formed on the side surface of the disc cartridge 1.

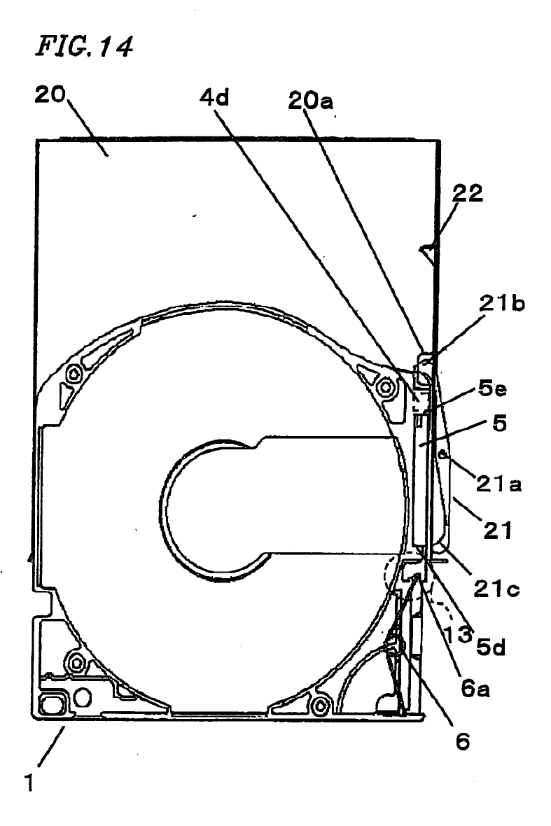

FIGS. 14 through 18 are cutaway plan views of important parts showing the lock release operation of the disc cartridge 1. FIGS. 14 through 18 illustrate the disc cartridge 1 with the upper half 3 being omitted for the sake of assisting understanding the operation inside.

The locking portion 13 locks the shutter 5 using the shutter driving spring 6 such that the shutter 5 does not open the opening 4a.

At first, as shown in FIG. 14, the disc cartridge 1 is started to be inserted into the holder 20. The lock release portion 21c is retracted to outside the holder 20. Thus, the disc cartridge 1 is not prevented from being inserted and the disc cartridge 1 is inserted until a tip of the disc cartridge 1 abuts the cartridge abutment portion 21b. At this time, the opener pawl 20a starts to enter the side surface notch 3a.

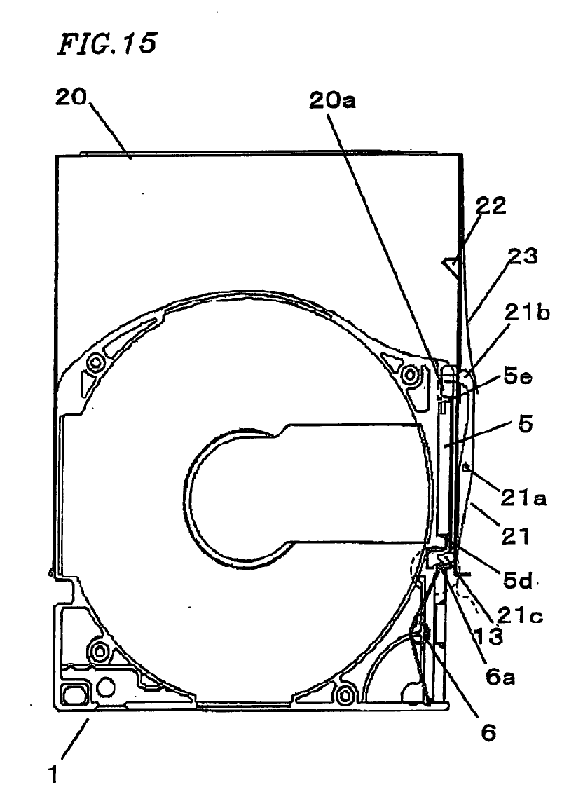

Next, as shown in FIG. 15, the cartridge abutment portion 21b abuts the side surface of the disc cartridge 1 and is pushed out from the holder 20. Thus, the lock release lever 21 partially rotates and the lock release portion 21c on the other end is inserted into the notch 5d of the shutter 5. At this point, the opener pawl 20a has not yet reached the opener abutment surface 5e of the shutter 5.

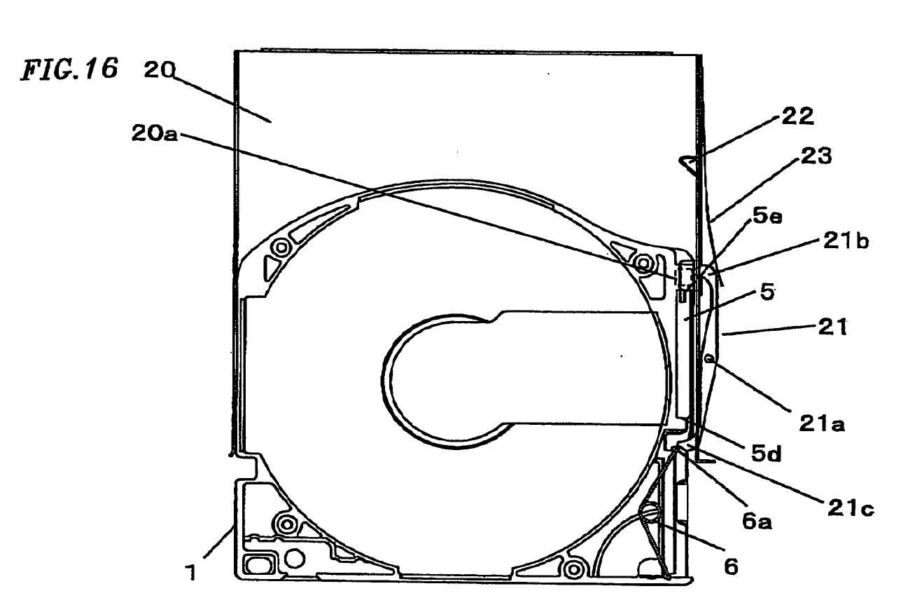

Then, as shown in FIG. 16, as the opener pawl 20a abuts the opener abutment surface 5e of the shutter 5, the lock release portion 21c presses the tip portion 6a of the shutter driving spring 6 inward to release the lock.

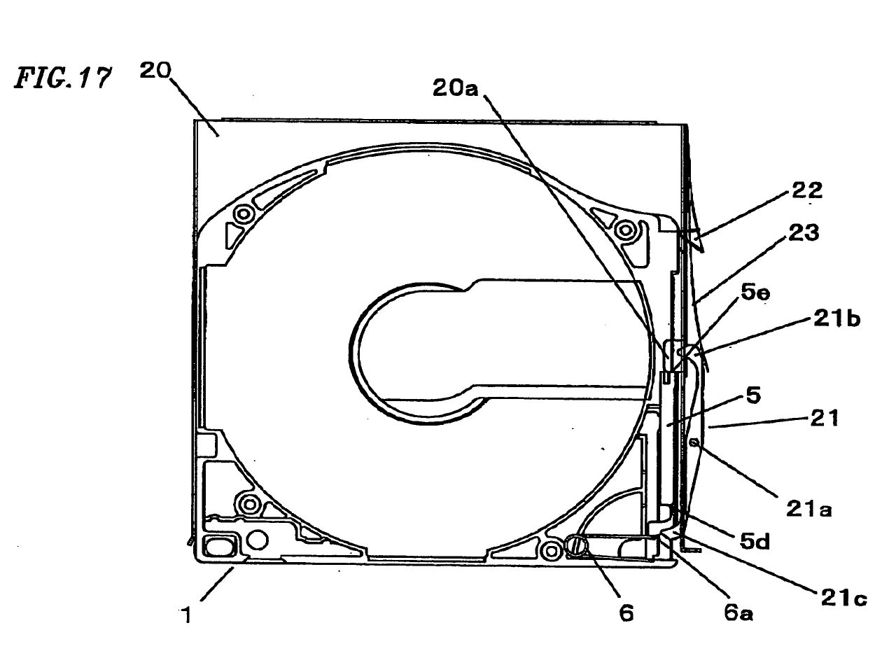

As shown in FIG. 17, when the disc cartridge 1 is further inserted, the shutter 5 stopped by the opener pawl 20a. Only the cartridge body 1A advances to open the opening 4a. The shutter driving spring 6 is pressed by the shutter 5 and moves. In this state, the holding spring 22 is pressed to the side surface of the disc cartridge 1.

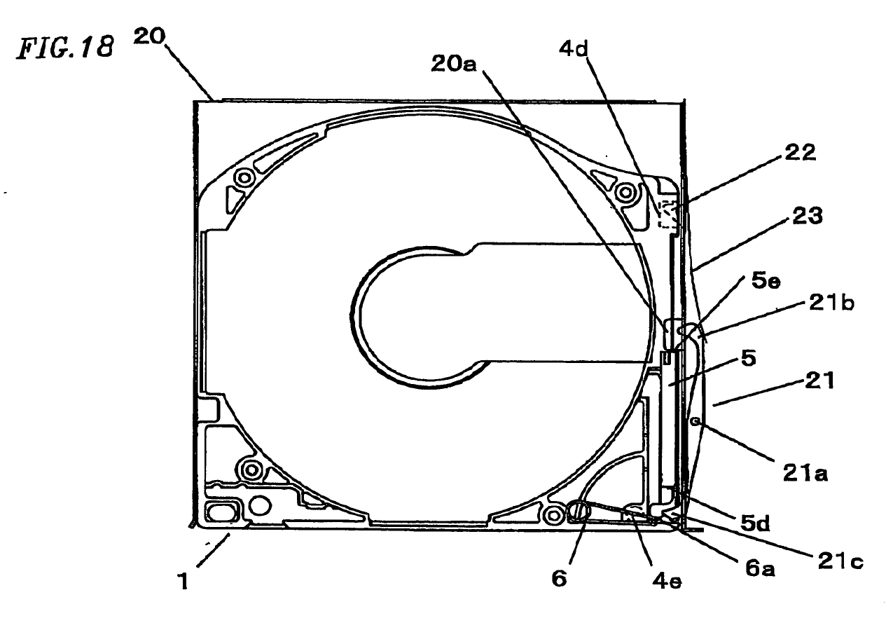

Next, as shown in FIG. 18, the disc cartridge 1 is inserted into the innermost part of the holder 20 and the holding spring 22 holds the disc cartridge 1 with the holding portions 4d. Thus, the disc cartridge 1 is completely inserted into the holder 20. The shutter 5 is completely at the opening position. The recording/reproduction head and the spindle can be inserted into the opening 4a. Thus, it is possible to record information on the disc 2 or reproduce information from the disc 2.

The shutter driving spring 6 is formed such that it can be moved to a position above the positioning hole 4e. Thus, even in a structure in which the positioning hole 4a is located in a region of the movement of the shutter driving spring 6, the shutter driving spring 6 having a sufficient size can be used, and thus, a force to press the shutter 5 can be freely adjusted.

For removing the disc cartridge 1 from the holder 20, an eject mechanism can be further provided. When the eject mechanism releases the head state by the holding spring 22, the disc cartridge 1 is pushed out by a repulsive force of the shutter driving spring 6. As described above, the holder 20 can serve as a shutter lock release apparatus.

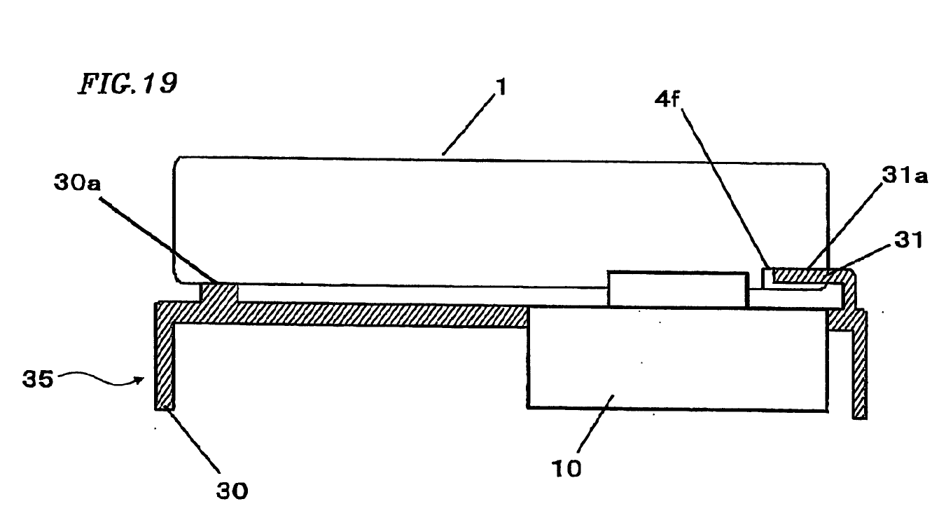

FIG. 19 in a schematic diagram showing the disc cartridge 1 when it is mounted to a disc drive apparatus 35.

The disc cartridge 1 is installed on a mechanical chassis 30 of the disc drive apparatus 35. Installation surfaces 30a of the mechanical chassis 30 support the major surface of the lower half 4 of the disc cartridge 1 (in general, in the vicinity of the positioning holes 4e) as reference planes. Thus, the disc cartridge 1 is positioned with respect to its height.

However, providing only a pair of the installation surfaces 30a in the vicinity of the side surfaces of the disc cartridge 1 in a direction of movement of the shutter 5 opening the opening 4a means that the disc cartridge 1 is defined by only the reference planes on one side of the disc cartridge 1. This is not preferable. Therefore, it is necessary to provide the installation surfaces corresponding to reference planes across a region of movement or the recording/reproduction head 10 or the disc drive apparatus 35.

In the present embodiment, the disc cartridge 1 has an R-shape protrusion protruded into an R-shape in the vicinity of the opening 4a. In such a disc cartridge 1, if the installation surface protruded from the mechanical chassis 30 to the disc cartridge 1 is provided so as to correspond to the reference plane in the vicinity of the R-shape protrusion, the recording/reproduction head 10 abuts the protrusion of the reference planes. Thus, there is a problem that is difficult to miniaturize the disc cartridge 1. Therefore, it is difficult to use portions which oppose the installation surfaces 30a via the opening 4a as reference planes in the cartridge 1 protruding into an R-shape in terms of a space.

Therefore, the corner recessed portions 4f having planar portions out from the major surface of the lower half 4 are provided. Thus, the installation surfaces 31 corresponding to the corner recessed portions 4f can be located at a higher position. Therefore, it becomes possible to minimize the gap between the recording/reproduction head 10 and the disc cartridge 1 and reduce the thickness of the disc drive apparatus. Furthermore, the corner recessed portions 4f are supported by the installation surfaces 31a. Thus, it is possible to ensure the installation in the disc drive apparatus 35 for driving the disc 2 and to assure the operation accuracy in recording/reproduction of the disc 2.

Further, since the corner recessed portions 4f are provided so as to be orthogonal to the direction of inserting the disc cartridge 1, the installation surfaces 31 may be formed in a direction either from a tip side or a side surface side of the disc cartridge 1.

In the present embodiment, the structure in which two corner recessed portions 4f are provided has been described. However, typically, there is spare room in the vicinity of the side surface to be engaged with the plate portion 5f of the shutter 5 on the tip side in the direction of inserting into the disc drive apparatus. Thus, a corner recessed portion 4f may be provided in this portion. The structure in which two corner recessed portions 4f are provided as in the present embodiment is preferable since the degree of freedom in terms of arrangement and movement of the recording/reproduction heads or the like can be improved.

In the present embodiment, the disc cartridge having the R-shape protrusion has been described. Of course, the disc cartridge according to the present invention can be applied to the disc cartridge having a rectangular shape. In the present embodiment, the disc cartridge having the opening on one side has been explained as an example. However, the present invention can be applied to the disc cartridge having openings on both sides as long as the shutters are provided on both sides via the upper engagement protrusions, the lower engagement protrusions, or the like to be engaged with the side surfaces of the cartridge body.

Furthermore, in the present embodiment, the leaf spring is used as the spring for applying force. However, the force may be applied by a torsion spring between the cartridge abutment portion and the mechanical chassis, for example. A means for applying a force can be appropriately set.

### Embodiment 2

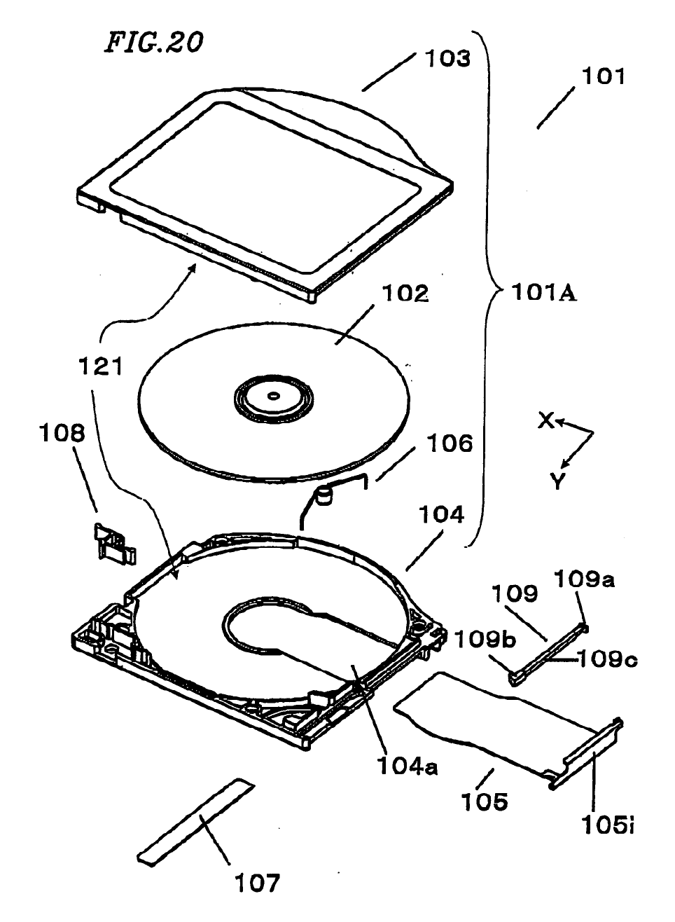

FIG. 20 is an exploded perspective view showing a disc cartridge 101 according to Embodiment 2 of the present invention.

The disc cartridge 101 has a substantially similar structure as that of the disc cartridge 1 which has been described with reference to FIG. 1 regarding Embodiment 1 except for further including a lock release member 109. Therefore, for the sake of simplicity of the description, description of the structure that is the same as that already described with reference to FIG. 1 regarding Embodiment 1 will be omitted. In the following description, components of the disc cartridge 101 which correspond to the components of the disc cartridge 1 are referred to by the same name as those described in Embodiment 1. Furthermore, it should be noted that the reference numerals of the components of the disc cartridge 101 which correspond to the components of the disc cartridge 1 have the two last digits same as those of the reference numerals of the components of the disc cartridge 1 described in Embodiment 1.

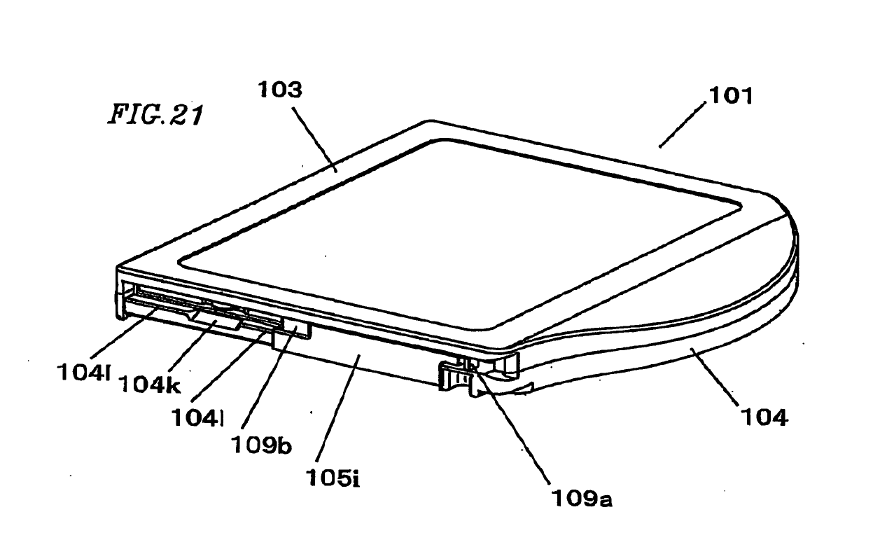

FIG. 21 is a perspective view mainly showing an outer surface of an upper half 103 of the disc cartridge 101 with a shutter 105 closing an opening 104a.

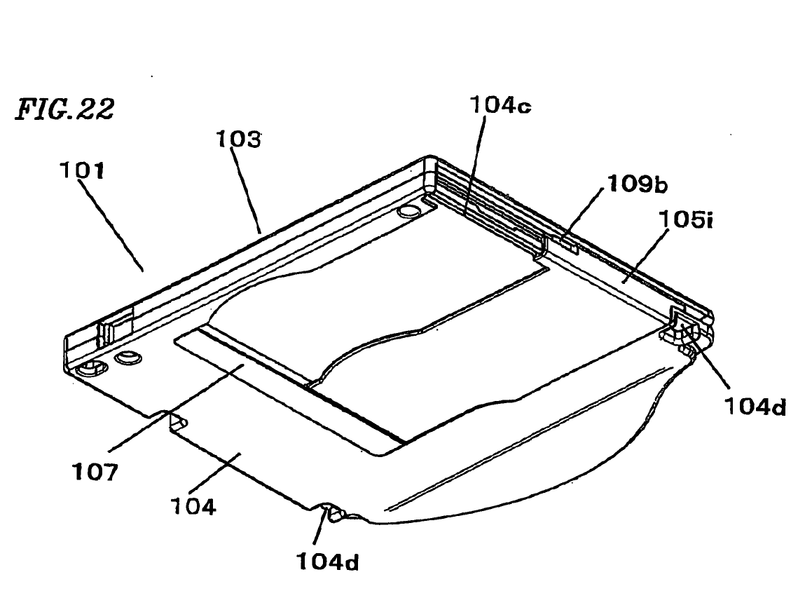

FIG. 22 is a perspective view mainly showing an outer surface of a lower half 104 of the disc cartridge 101 with the shutter 105 closing the opening 104a.

As shown in FIGS. 21 and 22, on a side surface of the disc cartridge 101 to which the shutter 105 is engaged, the lock release member 109 covers a tip portion 106a of a shutter driving spring 106 which is exposed from a notch 105d of the shutter 105 without being covered by a raised portion 104p. Thus, basically, the gap from the outside of cartridge body 101A through to the disc 102 has only a width required for allowing a squared C-shaped upper surface portion 105g to pass. Further, at the closing position of the shutter 105, the opening 104a is completely covered. A lower engagement groove portion 104c does not communicate with the opening 104a. Thus, there is no path for dust to enter, which enables a highly dust-proof structure.

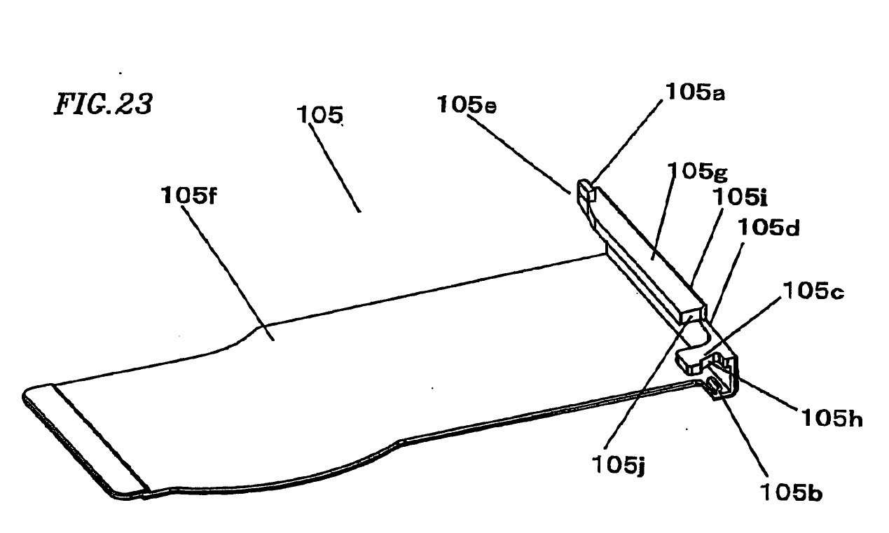

FIG. 23 is a perspective view showing a structure of the shutter 105.

On one end of the plate portion 105f for closing the opening 104a at a closing position of the shutter 105, a squared C-shaped side wall portion 105i and the squared C-shaped upper surface portion 105g formed by, for example, bending a metal plate into a substantially squared C-shape with a bending process or the like, are provided. They are assembled so as to pinch the lower half 104.

On one end of an upper surface of the squared C-shaped upper surface portion 105g, an upper engagement protrusion 105a is provided. On an upper surface of the plate portion 105f, a lower engagement protrusion 105b is provided. The upper engagement protrusion 105a is provided so as to have a diagonal relationship with the lower engagement protrusion 105b.

A spring engagement portion 105c is formed above the lower engagement protrusion 105b at a position lower than an upper side surface of the squared C-shaped upper surface portion 105g. The upper side surface of the squared C-shaped upper surface portion 105g and the upper portion of the spring engagement portion 105c form a notch 105d.

A side end surface of the upper engagement protrusion 105a of the squared C-shaped upper surface portion 105g is a release member abutment surface 105e. A shutter opener pawl 120a of the disc drive apparatus (not shown) abuts the release member abutment surface 105e via the lock release member 109, and thus, the shutter 105 moves to open the opening 104a (the details will be described later).

An edge surface 105j which opposes to the release member abutment surface 105e of the squared C-shaped upper surface portion 105g and is closer to the shutter driving spring 106 is engaged with the tip portion 105a of the shutter driving spring 106.

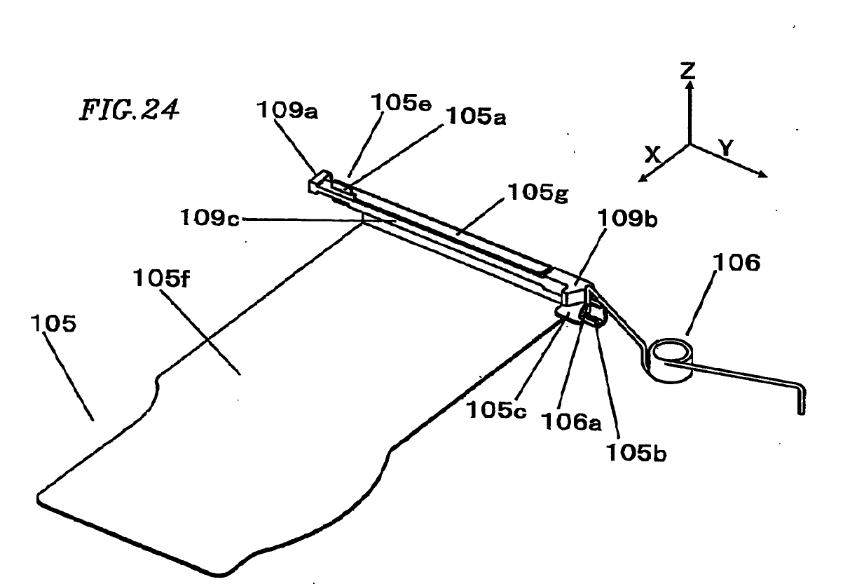

FIG. 24 is a perspective view of an important part illustrating a structure around the shutter of Embodiment 2.

With reference to FIG. 24, arrangements and relationships between the shutter 105, the shutter driving spring 106 and the lock release member 109 is described.

The lock release member 109 has, for example, an opener abutment portion 109a to abut the shutter opener pawl 120a provided in the disc drive apparatus (not shown), a contact portion 109b to be engaged with the tip portion 106a of the shutter driving spring 106, and a connecting portion 109c for connecting the opener abutment portion 109a and the contact portion 109b.

The connecting portion 109c is incorporated in a space formed by the squared C-shaped side wall portion 105i, the squared C-shaped upper surface portion 105g, and the spring engagement portion 105c so as to be slidable with these components.

The thickness of the lock release member 109 in Z direction can be made smaller than those of the opener abutment portion 109a and the contact portion 109b so as to reduce the thickness of the disc cartridge 101 in the Z direction. Therefore, it is possible to prevent dust from entering the cartridge body 101A and contaminating the disc 102. A distance of a sliding movement of the lock release member 109 in the Y direction can also be controlled. An engagement surface of the contact portion 109b to be engaged with the tip portion 106a of the shutter driving spring 106 inclined opposite to an inclined portion of the spring engagement portion 105c.

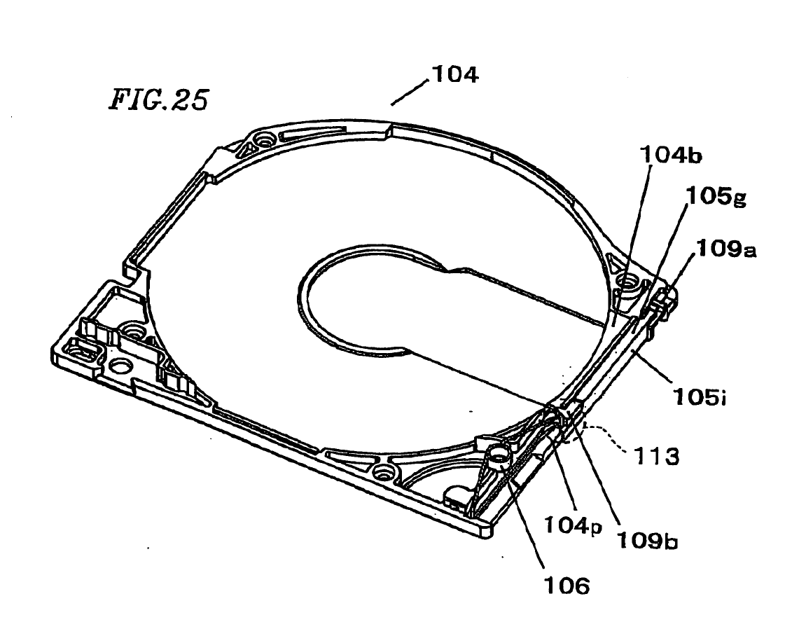

Next, with reference to FIGS. 25 through 29, an operation for opening the shutter 105 in the disc cartridge 101 of Embodiment 2 in described.

FIG. 25 is a perspective view of in important part showing the inner surface of the lower half 104 of the disc cartridge 101 with the shutter 105 in Embodiment 2 closing the opening 104a. Herein, the locking portion 113 locks the shutter 105 using the shutter driving spring 106 such that the shutter 105 does not open the opening 104a.

FIG. 25 shows arrangements of each of the lower half 104, the shutter 105, the shutter driving spring 106, and the lock release member 109.

For actually incorporating these components, the lock release member 109 is located along a space formed by the squared C-shaped upper surface portion 105g, the squared C-shaped side wall portion 105i, and the spring engagement portion 105c. With the lower engagement protrusion 105b provided on the shutter 105 being guided to the lower engagement groove portion 104c provided on the lower half 104, the shutter 105 is mounted to the lower half 104. Then, the shutter driving spring 106 is incorporated between the spring abutment surface 105h of the spring engagement portion 105c and the spring supporting portion 104j with a force being applied. The components are assembled into a state as shown in FIG. 25.

Thus, the shutter 105 and the lock release member 109 are incorporated to the lower half 104. Furthermore, when the shutter driving spring 106 is incorporated, the shutter 105 is pushed back to the closing position by a repulsive force of the shutter driving spring 106. At the same time, the lock release member 109 in also pushed back. The opener abutment portion 109a is stopped in a state being protruded in a direction of closing the shutter. In this state, if the shutter 105 is tried to be moved in an opening direction, the tip portion 106a of the shutter driving spring 106 between the shutter engagement portion 105c and the raised portion 104p blocks the movement in the opening direction. Thus, it is possible to completely suppress the shutter 105 being opened by an unnecessary external force or the like, and foreign matters such as damages, dust, and/or fingerprints of a human hand being attached on the disc 102.

An example of operation for opening the shutter 105 from this state is described.

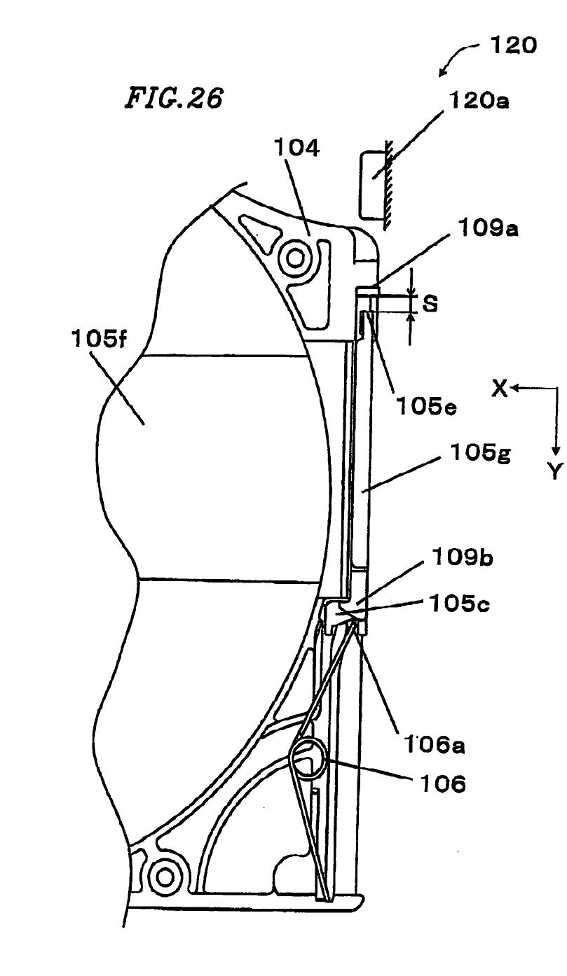

FIGS. 26 through 29 are cutaway plan views of important parts showing a process for putting a disc cartridge 101 of Embodiment 2 on, for example, a tray, and a process for mounting the disc cartridge 101 to a holder 120 of the disc drive apparatus with the upper half 103 and the disc 102 being omitted.

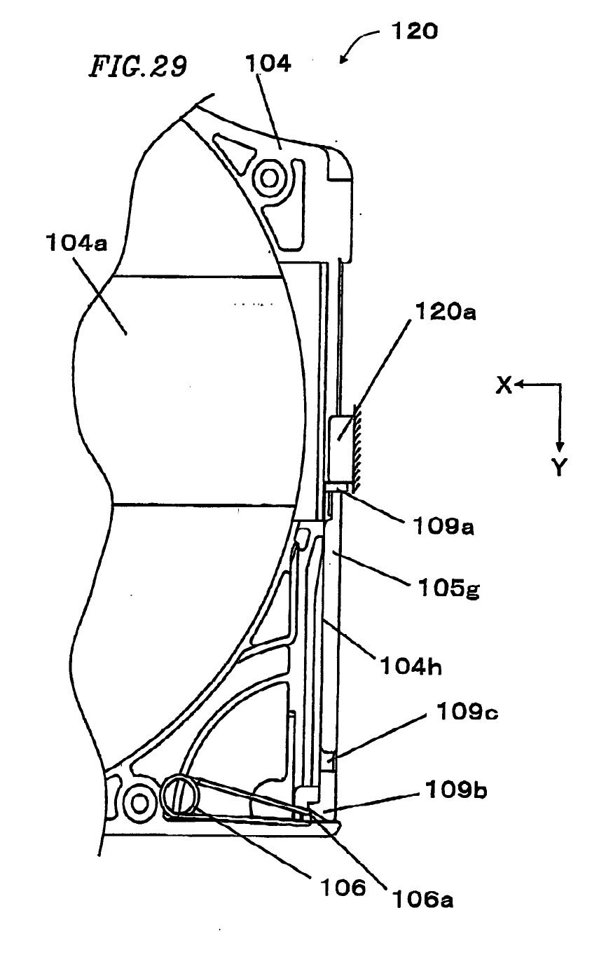

With reference to FIG. 26 showing a state immediately before the disc cartridge 101 is inserted through FIG. 29 showing a state when the shutter 105 opens the opening 104a, this operation is described.

When the disc cartridge 101 is put on a tray (not shown), as shown in FIG. 26, it enters a state before the opener pawl 120a provided on the holder 120 of the disc drive apparatus (not shown) and enters a gap between the upper half 103 and the lower half 104. In this state, a force applied by the shutter driving spring 106 acts on the engagement surface of the contact portion 109b. Thus, the lock release member 109 pressed toward the opener abutment portion 109a and has a gap of a distance S between the release member abutment surface 105e and the opener abutment portion 109a (of course, the connecting portion 109c can be seen via this gap).

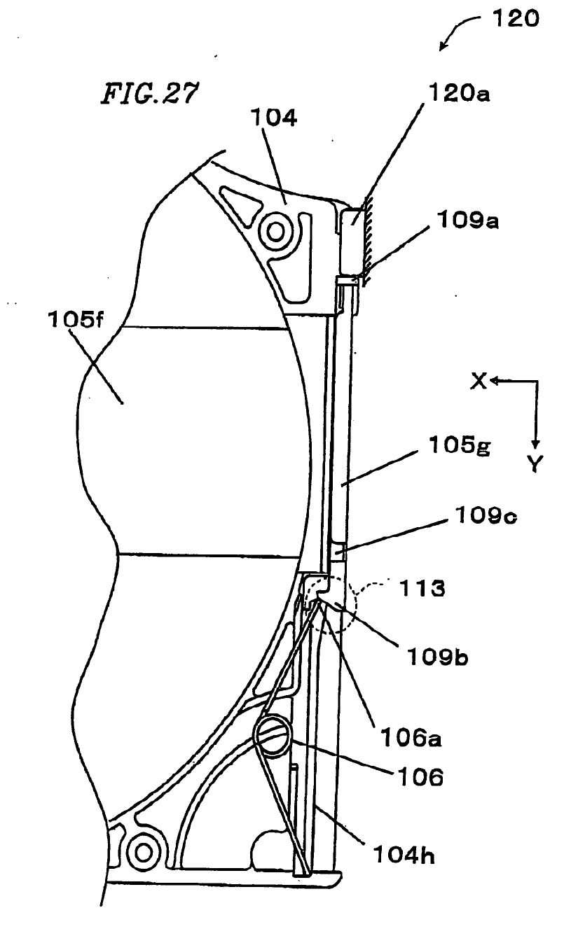

When the disc cartridge 101 is inserted by the distance S, as shown in FIG. 27, the opener abutment portion 109a and the release member abutment surface 105e abut each other. The abutment surface of the contact portion 109b is inclined toward the disc 102. Thus, when the lock release member 109 is pushed by the distance S, the abutment surface presses the tip portion 106a in a direction of the disc 102 (i.e., X direction). The tip portion 106a moves along the spring abutment surface 105h, and the lock of the shutter 105 is released.

Accordingly, it is necessary that the distance S is equal to or larger than the distance for the tip portion 106a to slide along the abutment surface and reach a spring sliding surface 104h. The length of the distance S is correlated to an angle of an incline of the abutment surface and can be appropriately set to an optimum value.

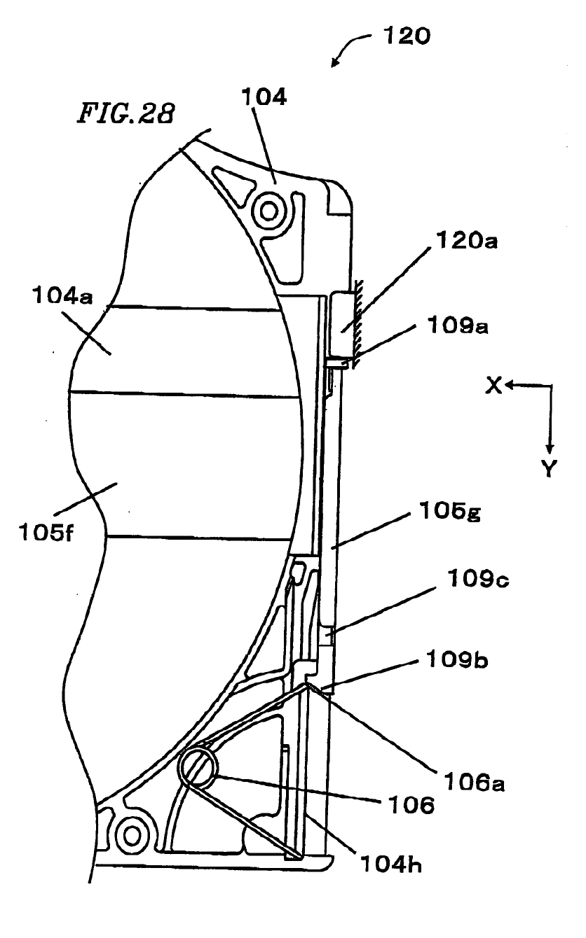

The lock of the shutter 105 by the tip portion 106a is released. As the disc cartridge 101 is further inserted, the opener pawl 120a presses the release member abutment portion 105e via the opener abutment portion 109a and deforms the shutter driving spring 106. As shown in FIG. 28, the opening 104a which has been closed by the plate portion 105f of the shutter 105 is opened.

An area of the opener abutment portion 109a is larger than an area of the release member abutment surface 105e. Thus, the lock release member 109 moves integrally with the shutter 105. The shutter driving spring 106 moves toward the disc 102 (i.e., in the X direction) by deformation. Movement accompanied by the deformation can be absorbed by appropriately setting the gap between a disc holding portion 104d and a side wall of the lower half 104. An influence on an operation of the shutter 105 to open the opening 104a can be avoided.

When the disc cartridge 101 is further inserted, as shown in FIG. 29, an operation for opening the shutter 105 is finished when the contact portion 109b abuts a side wall of the lower half 104 on the rear side with respect to the direction of insertion (hereinafter, referred to as the rear side wall). The opposing 104a is completely opened.

As described above, the holder 120 serves as a shutter lock release device.

In the above description of the present embodiment, a structure in which the contact portion 109b abuts the rear side wall has been described. Of course, a partition may be provided on the forward side in the insertion direction of rather than on the rear side wall to finish the opening operation of the shutter 105 as long as the plate portion 105f completely opens the opening 104a.

In the present embodiment, a structure in which the tip portion 106a of the shutter driving spring 106 in moved into the disc cartridge 101 to release the lock has been described. However, the lock may be released by moving the tip portion 106a outside. A structure of the spring and a shape of a tip of the lock release number can be appropriately designed.

Further, although the shutter driving spring 106 uses the helical torsion spring, other elastic bodies may be used.

As described above, according to the present invention, the lock releasing operation of the shutter 105 and the opening operation of the opening 104a are performed by opener pawl 120a. Thus, it is not required to further provide the lock release mechanism in the disc drive apparatus such as a recording/reproduction apparatus. Therefore, it is possible to extremely simplify the structure of the disc drive apparatus and to reduce the cost for the disc drive apparatus.

When the shutter 105 opens the opening 104a, it does so after the lock of the shutter 105 is released. When the shutter 105 closes the opening 104a, the shutter 105 is securely locked after the opening 104a is closed. Thus, the reliability of the lock and the lock release operations of the shutter 105 can be improved. In other words, the disc cartridge according to the present invention has a significant effect of securely preventing the opening 104a from being carelessly opened by an external force when the opening 104a in closed by the shutter 105 and achieving the operation of opening the opening 104a with an extremely simple apparatus structure when the opening 104a is opened by the shutter 105.

Further, the lock release member 109 can be within a region of a gap, for example, through which the opener pawl 120a formed on the side surface of the disc cartridge 101 can pass. Thus, the lock release member 109 does not increase the thickness of the disc cartridge 101 in a direction orthogonal to the disc and an area of the disc cartridge 101 in a planar direction of the disc 102.

### INDUSTRIAL APPLICABILITY

As described above, according to the disc cartridge of the present invention, both closing and opening by moving a shutter member using a shutter driving spring, and preventing the shutter member from being opened carelessly by a user handling the apparatus in a closed state to close the opening can be implemented. Thus, a disc in the disc cartridge can be securely protected by an inexpensive structure.

The shutter driving spring performs a plurality of functions, such as closing of the opening and locking of the shutter member. Therefore, the size of the cartridge can be reduced compared to that in the case where similar functions are respectively performed by dedicated parts.

Further, it is not necessary to provide a new locking mechanism on a tip of the disc cartridge to be inserted into a disc drive apparatus. Thus, the degree of freedom in a design in appearance increase and it is possible to employ a novel form having a large curvature on the tip. It is also possible to locate components of the disc drive apparatus in a portion having a curvature. As a result, a disc cartridge which can contribute to miniaturization of the disc drive apparatus can be implemented.

According to one embodiment of the present invention, it is possible to locate the shutter driving spring without reducing an area of a space for the shutter driving spring. Thus, the form of the shutter driving spring can be simplified, the cost of the shutter driving spring can be reduced, and the quality of the product can be improved. Furthermore, a positioning hole and a region of movement of the shutter driving spring communication with each other. Thus, the disc cartridge formed can be smaller than that in the case where positioning holes and the region of the movement of the shutter driving spring are separately formed in dedicated spaces.

According to one embodiment of the prevent invention, the shutter is locked by using the shutter driving spring in the closing state of the shutter. Thus, the shutter can be locked using a very simple structure without adding a new part for locking. Therefore, the disc cartridge can be produced at an inexpensive cost. Furthermore, a disc cartridge having a high reliability on a locking operation can be provided since the number of the parts does not increase.

According to one embodiment of the present invention, the lock of shutter can be released by directly pushing a tip portion of the shutter driving spring. Further, the tip portion of the shutter driving spring is in a guide groove portion provided on a side surface of the cartridge body. Thus, the lock can be prevented from being released due to a careless touch from outside the cartridge. Therefore, a safe locking release device can be provided. Further, the shutter of the disc cartridge enters a closing state by a force applied by the shutter driving spring. Thus, the disc cartridge has a good feeling of operation during removing the disc cartridge.

According to one embodiment of the present invention, when the shutter goes back from the opening state in which the shutter opens the opening to the closing state in which the shutter closes the opening, the tip portion of the shutter driving spring can be stably moved to the lock recessed portion. Thus, the reliability of the lock operation of the shutter can be improved. A condition of a surface abutment the tip portion of the shutter driving spring may be changed by repetitive use. Even in the case where friction efficiency during the movement of the shutter member increases due to such a change, the shutter can be locked with high reliability.

According to one embodiment of the present invention, a thickness of an engagement portion of the shutter member and the cartridge body can be reduced. Thus, it is possible to reduce the thickness of the disc cartridge. Further, the size of an optical pickup for recording information on or reproducing information from the disc housed in the disc cartridge can be reduced. This has a significant affect on miniaturization of an optical disc apparatus using the disc cartridge of the present application.

According to one embodiment of the present invention, the shutter member and the cartridge body are securely engaged, and the shutter member can be prevented from being detached from the cartridge body and damaging or similar the housed disc due to, for example, a force applied from outside the disc cartridge. This is also effective for reducing the thickness of the disc cartridge according to the present invention and reducing the size and the thickness of the disc drive apparatus.

According to one embodiment of the present invention, it is possible to implement the disc cartridge which has a high sealing ability and can prevent dust or the like from entering into the opening through a lower engagement groove.

According to one embodiment of the present invention, a lower surface of the bridging portion provided on the second case is substantially coplanar to a lower surface of the disc when chucked to a spindle, and an upper surface of the bridging portion forms a groove on a side surface of the cartridge body with a notch formed on an end of the first case. Thus, the guiding and holding of the shutter member are not affected. There is less necessity in restricting the size of the optical pickup of a portion outer the periphery of the disc. The restriction on the arrangement of the optional pickup in the disc drive apparatus can also be reduced. Thus, it is possible to implement reduction of the thickness and the size of the optical pickup apparatus using the disc cartridge of the present invention.

According to one embodiment of the present invention, even when the optical pickup apparatus moving below the opening across the inner periphery to the outer periphery of the disc is at the outer periphery side of the disc, a cartridge installation portion provided on a chassis or the like of the disc drive apparatus for installing the cartridge body does not interfere with the optical pickup with respect to a height direction. Thus, the thickness of the disc drive apparatus ran be reduced. This causes a large effect particularly in the a disc drive apparatus using the disc cartridge which houses disc having a smaller diameter compared to the size of the optical pickup device.

According to one embodiment of the present invention, when the disc cartridge is inserted into the cartridge holder, the shutter lock release operation can be implemented with a very simple structure. Accordingly, miniaturization of the cartridge holder device, and thus miniaturization of the disc drive apparatus can be implemented.

According to one embodiment of the present invention, when the disc cartridge is inserted into the cartridge holder, the end for releasing the shutter locking means does not abut the tip of the cartridge. Thus, it is possible to provide a high grade shutter lock releasing device which does not cause scratches on the cartridge body or an unpleasant sensation when the disc cartridge is inserted.

According to the disc cartridge of one embodiment of the present invention, the shutter driving spring implements both the shutter member closing an opening and prevents the shutter member carelessly opening the opening due to handling by a user after the shutter member it closed. Thus, a disc in the disc cartridge can be securely protected with an inexpensive structure. Further, the shutter driving spring performs a plurality of functions, such as pushing back the shutter and locking the shutter. Therefore, it is possible to have a structure in which mechanisms are concentrated to one place compared to that in the case where similar functions are respectively performed by dedicated parts. As a result, the size of the disc cartridge can be reduced. Further, it is not necessary to provide a new locking mechanism on the tip. Thus, a degree of freedom in design in appearance increases and it is possible to employ a novel form having a large curvature on the tip. It is also possible to locate components of the disc drive apparatus in a portion having a curvature in order to contribute to miniaturization of the disc drive apparatus.

Further, it is no longer necessary to provide a locking mechanism on the tip in a direction of inserting the cartridge into the disc drive apparatus, and a lock release portion for releasing the lock of the shutter using the shutter driving spring is provided in the disc cartridge. Thus, it is no longer necessary to provide a specialized lock release mechanism in the cartridge holder of the disc drive apparatus. Therefore, the size and the number of the parts of the disc drive apparatus can be reduced.

According to one embodiment of the present invention, the lock release portion releases the lock by moving in a direction that the shutter member opens the opening. Thus, the lock release operation is possible with a significantly simple structure, for example, a structure in which an opener pawl is provided in the disc drive apparatus for driving the cartridge to a recording/reproduction section for recording or reproducing the disc housed in the cartridge. The structure of, for example, the cartridge holding portion of the disc drive apparatus can be extremely simple. This has a large influence on reducing cost of the disc drive apparatus and reliability thereof. More specifically, in such a structure, the shutter opens the opening after the lock release portion releases the lock of the shutter by the shutter driving spring. Thus, the reliability of the operation of the shutter opening the opening is high. Regarding the closing operation, reliability is also high since the lock release portion slides the shutter in a direction or closing the shutter in a squared C-shape bent portion of the shutter and the shutter lock mechanisms can be restored by the shutter driving spring.

According to one embodiment of the present invention, the lock release portion is pressed by the opener pawl to release the lock and moves to the opening position with the shutter member after it finishes releasing the lock. Thus, the lock release portion and the opener pawl do not interfere with each other and retraction space for the lock release portion is not required in the cartridge. Thus, the cartridge can be miniaturized.

1. A disc cartridge, comprising:
a cartridge body including a disc housing section for housing a disc so as to be rotatable, which is provided with an opening for exposing a part of the disc;
a shutter member which is movable to open or close the opening;
a shutter driving spring for applying a force to the shutter member not to open the opening; and
a locking portion for locking the shutter member.

2. A disc cartridge according to claim 1, wherein the locking portion is locked using the shutter driving spring.

3. A disc cartridge according to claim 1, wherein:
the cartridge body includes a first case and a second case; and
the first case and the second case are integrally combined to form a disc housing section.

4. A disc cartridge according to claim 1, wherein the cartridge body is provided with positioning holes for defining the position of the disc cartridge with respect to a disc drive apparatus for driving the disc when the disc cartridge is mounted to the disc driving apparatus.

5. A disc cartridge according to claim 4, wherein:
the cartridge body includes a first case and a second case;
the first case and the second case are integrally combined to form a disc housing section; and
the positioning holes are provided so as not to penetrate the first case and the second case.

6. A disc cartridge according to claim 2, wherein:
the shutter member includes a spring engagement portion to be engaged with the shutter driving spring; and
the shutter member and the shutter driving spring slide in the spring engagement portion at a substantially right angle with respect to a direction of a movement of the shutter member in a closing state in which the shutter member closes the opening.

7. A disc cartridge according to claim 2, wherein the cartridge body is provided with a lock recessed portion to which the shutter driving spring is engaged at a substantially right angle with respect to a direction of the movement of the shutter member in a closing state in which the shutter member closes the opening.

8. A disc cartridge according to claim 2, wherein:
a recessed-shape guide groove portion which is opened to the outside of the cartridge body is provided on a side surface of the cartridge body to be engaged with the shutter member; and
one end of the shutter driving spring moves along the guide groove portion.

9. A disc cartridge according to claim 8, wherein an inclined surface for movement of the one end of the shutter driving spring to the lock recessed portion is provided on a surface of the spring engagement section to abut the one end of the shutter driving spring.

10. A disc cartridge according to claim 3, wherein:
the first case is provided with an upper engagement groove for guiding the movement of the shutter member and holding the shutter member; and
the second case is provided with a lower engagement groove for guiding the movement of the shutter member and holding the shutter member.

11. A disc cartridge according to claim 10, wherein the shutter member is provided with an upper engagement protruded portion to be engaged with the upper engagement groove, and a lower engagement protruded portion to be engaged with the lower engagement groove.

12. A disc cartridge according to claim 11, wherein the lower engagement groove is provided so as to be spaced apart from the opening by a predetermined distance.

13. A disc cartridge according to claim 3, wherein:
a bridging portion for bridging an outer periphery portion of the opening is provided in the second case;
the bridging portion has a lower surface substantially coplanar to a surface of the disc when a disc drive apparatus for driving the disc drives the disc and an upper surface which is a surface coplanar to a surface of the opening close to an edge of the cartridge body and is extended in a direction of closing the shutter member;
a side surface of the first case is provided with a notch; and
the notch of the first case and the upper surface of the bridging portion form a groove.

14. A disc cartridge according to claim 3, wherein:
the second case is provided with an opening range restriction portion for restricting an opening area of the shutter member;
a major surface of the second case to be mounted on a disc drive apparatus for driving the disc is provided with planar holding portions recessed from the major surface in the vicinity of corners to which the shutter member is engaged which opposes the open area restriction portion via the opening.

15. A disc cartridge according to claim 1 further comprising a lock release portion for releasing the lock of the locking member.

16. A disc cartridge according to claim 15, wherein the lock release portion is in contact with the shutter driving spring.

17. A disc cartridge according to claim 15, wherein the lock release portion comprises a pressed portion to be pressed by a disc drive apparatus for driving the disc, and the lock release portion is provided so as to be movable in a direction that the shutter member opens or closes the opening.

18. A disc cartridge according to claim 15, wherein the lock release portion enters a lock released state by pressing the pressed portion with the shutter member closed and locked, and then moves with the shutter member to the opening position integrally with the shutter member.
